(19) United States
(12) Patent Application Publication
(10) Pub. No.: US 2005/0174434 A1
(43) Pub. Date: Aug. 11, 2005

(54) Camera lens interface device

(76) Inventors: Jyun-Bei Chang, Tai-Chung City (TW); Jing-Shian Chang, Tai-Chung City (TW); Yea-Tsyr Chang, Tai-Chung City (TW); Bor-Yann Chang, Tai-Chung City (TW)

Correspondence Address: CHARLES E. BAXLEY, ESQ., 90 JOHN STREET, THIRD FLOOR, NEW YORK, NY, 10038, US

(21) Appl. No.: 11/052,550

(22) Filed: Feb. 7, 2005

(30) Foreign Application Priority Data
Feb. 10, 2004 (TW) 093201872

(51) Int. Cl. H04N 5/232

(52) U.S. Cl. 348/211.1

(57) ABSTRACT

Disposed is a camera lens interface device for detachably connecting a camera lens module to a mobile electronic apparatus wirelessly or through a cable, for enabling the mobile electronic apparatus to control the camera lens module to pick up video images for display on the display screen of the mobile electronic apparatus.

### BACKGROUND OF THE INVENTION

1. Field of the Invention

The present invention relates to a mobile communication/information apparatus and more particularly, to a camera lens interface device adapted to connect an external camera lens module to a mobile communication/information apparatus.

2. Description of the Related Art

A mobile electronic apparatus such as mobile communication apparatus or mobile information apparatus may have a built-in camera lens module for photographing. More particularly, after the development of 3 G wireless communication services, a user can transmit live pictures to a remote communication or information apparatus wirelessly through a wideband 3 G communication system. When using a mobile electronic apparatus with a built-in camera or attached camera to take video images, the user must hold the mobile electronic apparatus with the hands and aim it at the object to be photographed. When the object is moving, the user must move the body and/or the mobile electronic apparatus subject to the movement of the object. If the user cannot move the body or the mobile electronic apparatus conveniently to fit the movement of the object, the user will not be able to take the video images of the moving object.

### SUMMARY OF THE INVENTION

The present invention has been accomplished under the circumstances in view. It is one object of the present invention to provide a camera lens interface device, which is practical for use between a mobile electronic apparatus and a camera lens module, enabling the mobile electronic apparatus user to take video images of a remote object through the camera lens module. It is another object of the present invention to provide a camera lens interface device, which fits different types of camera modules and different types of mobile electronic apparatus.

According to one embodiment of the present invention, a wireless camera lens interface device provided for connection between a camera lens module and a mobile electronic apparatus for enabling the mobile electronic apparatus to control the camera lens module to pick up video images. The camera lens module has a plug for connection to the wireless camera lens interface device. The wireless camera lens interface device comprises a camera lens slot adapted to receive the plug of the camera lens module; a voice pickup unit adapted to pick up external voices; a central processing unit adapted to receive and process video signal from the camera lens and voice signal from the voice pickup unit; a wireless communication module electrically connected to the central processing unit and adapted to receive and process video and voice signals from the central processing unit for transmitting to the mobile electronic apparatus wirelessly, and to receive and process signal from the mobile electronic apparatus for controlling the operation of the camera lens module through the central processing unit; antenna means electrically connected to the wireless communication module for receiving wireless signal from the mobile electronic apparatus and transmitting video and voice signals from the wireless communication module to the mobile electronic apparatus; a power unit adapted to provide power supply to the camera lens interface device and the camera lens module; and indicator light means for operation status indication. A camera lens adapter may be used to connect any of a variety of camera lens modules to the camera lens slot of the wireless camera lens interface device.

According to another embodiment of the present invention, a wired camera lens interface device is provided for connection between a camera lens module and a mobile electronic apparatus for enabling the mobile electronic apparatus to control the camera lens module to pick up video images. The camera lens module has a plug for connection to the wireless camera lens interface device. The mobile electronic apparatus has a socket for receiving the wired camera lens interface device, and a display screen for video image output. The wired camera lens interface device comprises a cable for signal and power transmission, the cable having a first end and a second end; a camera lens socket provided at the first end of the cable for receiving the connection plug of the camera lens module; and a plug provided at the second end of the cable for connection to the socket of the mobile electronic apparatus for enabling the mobile electronic apparatus to control the camera lens module to take video images for display through the display screen. A camera lens adapter may be used to connect any of a variety of camera lens modules to the camera lens slot of the wireless camera lens interface device. A mobile apparatus adapter may be used to connect any of a variety of mobile electronic apparatus to the wired camera lens interface device.

### BRIEF DESCRIPTION OF THE DRAWINGS

FIG. 1 is a schematic drawing illustration a wireless camera lens interface device in action according to the present invention.

FIG. 2 illustrates the outer appearance of the wireless camera lens interface device according to the present invention.

FIG. 3 is a schematic drawing illustration a wired camera lens interface device in action according to the present invention.

FIG. 4 illustrates the outer appearance of the wired camera lens interface device according to the present invention.

### DETAILED DESCRIPTION OF THE PREFERRED EMBODIMENT

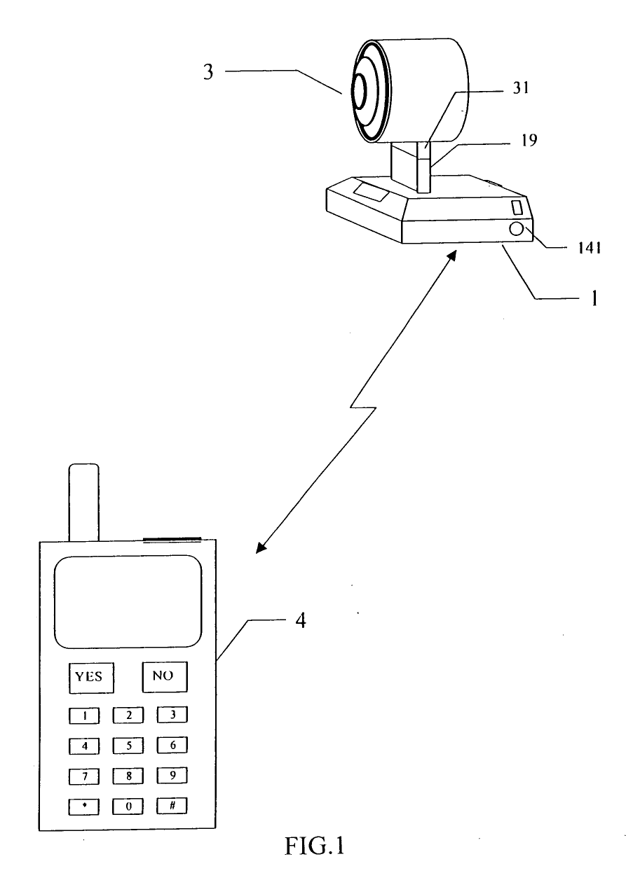

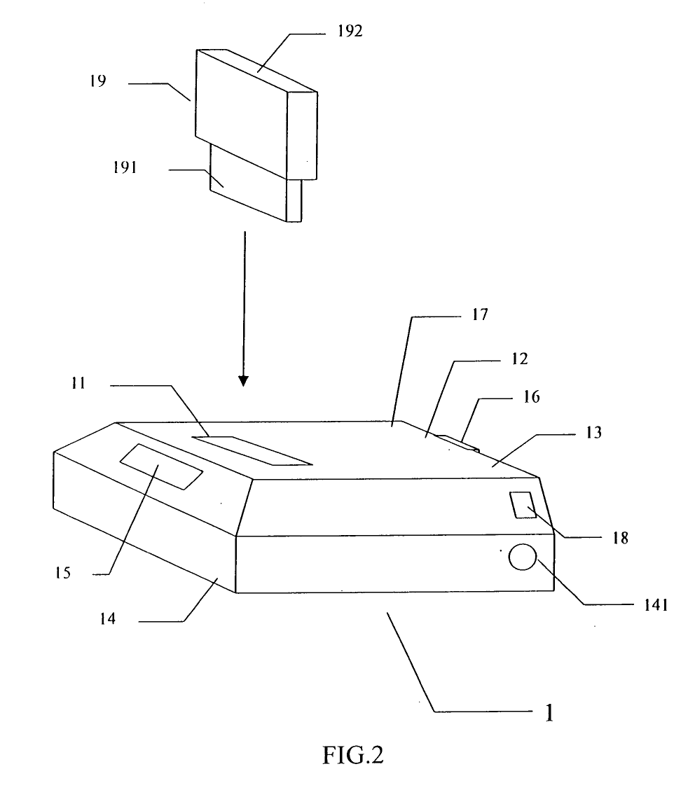

Referring to FIGS. 1 and 2, a wireless camera lens interface device 1 is shown comprising a camera lens slot 11, a wireless communication module 12, a CPU (central processing unit) 13, a power unit 14, a voice pickup unit (for example, fixed microphone) 15, an indicator light 16, an antenna 17, and a power switch 18.

The camera lens slot 11 is adapted to receive the connection plug 31 of a camera lens module 3. If the connection plug 31 of the camera lens module 3 does not fit the camera lens slot 11, a camera lens adapter 19 shall be used. The camera lens adapter 19 has a socket 191 at one end for receiving the connection plug 31 of a camera lens module 3 and a plug 192 at the other end for connection to the camera lens slot 11.

The wireless communication module 12 is adapted to modulate signal from the CPU 13 into modulated signal for transmitting into the air through the antenna 17, and to demodulate modulated signal received from an external mobile electronic apparatus 4 through the antenna 17 for further processing by the CPU 13. The wireless communication module 12 can be made to provide any of a variety of wireless signal transmitting functions such as local area wireless network function, bluetooth wireless communication function, or infrared wireless transmitting function to fit different mobile electronic apparatus. Alternatively, the wireless communication module 12 can be made to provide multiple wireless transmitting functions.

The CPU 13 is adapted to receive video signal from the external camera lens module 3 and voice signal from the voice pickup unit 15, to process received video signal and voice signal, and to send processed video signal and voice signal to the wireless communication module 12 for transmitting into the air through the antenna 17. The CPU 13 will also receive signal from the wireless communication module 12 for controlling the operation of the linked external camera lens module 3.

The power unit 14 provides all units of the wireless camera lens interface device 1 with the necessary working power. Preferably, the power unit 14 is a detachable battery pack compatible to the mobile electronic apparatus 4. The power unit 14 may be provided having a power circuit mounted inside the wireless camera lens interface device 1 and a power jack 141 provided at one end of the power circuit and exposed to the outside of the wireless camera lens interface device 1 for receiving external power supply.

The voice pickup unit 15 is installed in the front side of the wireless camera lens interface device 1 for picking up external voices and sending received voice signal for further processing and output through the CPU 13.

The indicator light 16 is adapted for power on/off and signal transmission on/off status indication, and power low indication.

The antenna 17 is adapted to transmit modulated signal from the wireless communication module 12 into the air, and to receive modulated signal from the outside air. The antenna can be an exposed type, or a conceived type. If the wireless communication module 12 provides multiple wireless transmitting functions, a compatible antenna or antenna assembly must be used.

The power switch 18 is adapted to control on/off status of the power unit 14 of the wireless camera lens interface device 1. An optional power control function may be provided for enabling the user to control on/off status of the power unit 14 of the wireless camera lens interface device 1 through the mobile electronic apparatus 4.

After insertion of the external camera lens module 3 into the camera lens slot 11 directly or through the camera lens adapter 19, the power supply of the wireless camera lens interface device 1 and the power supply of the mobile electronic apparatus 4 are respectively turned on, and then the wireless camera lens interface device 1 with the attached camera lens module 3 are placed on the desired place, keeping the camera lens module 3 aimed at the object to be photographed. Thereafter, the user can operate the mobile electronic apparatus 4 to pick up video images of the object, enabling the received video images to be displayed on the display screen of the mobile electronic apparatus 4.

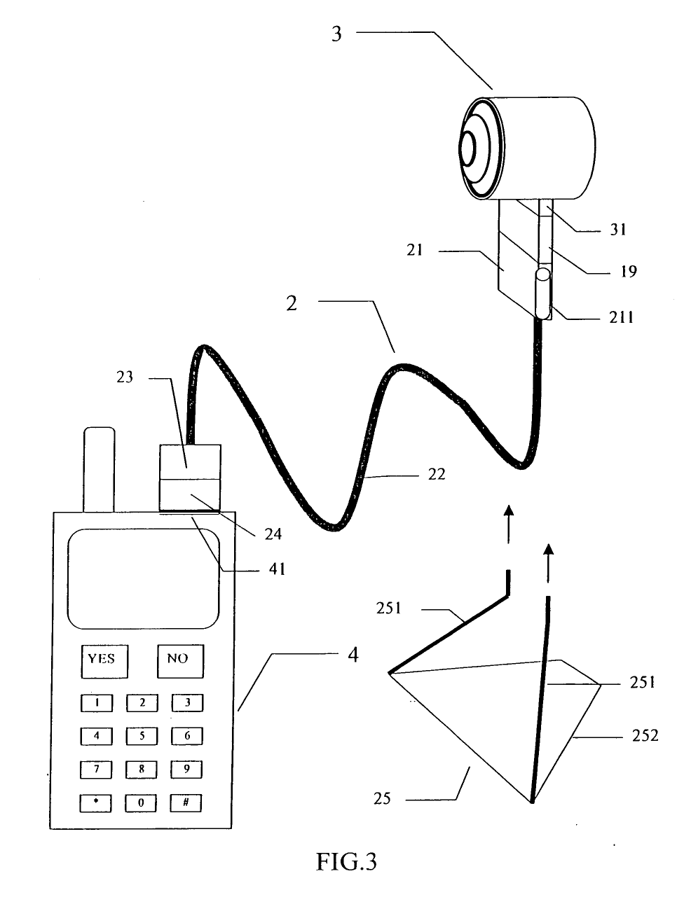

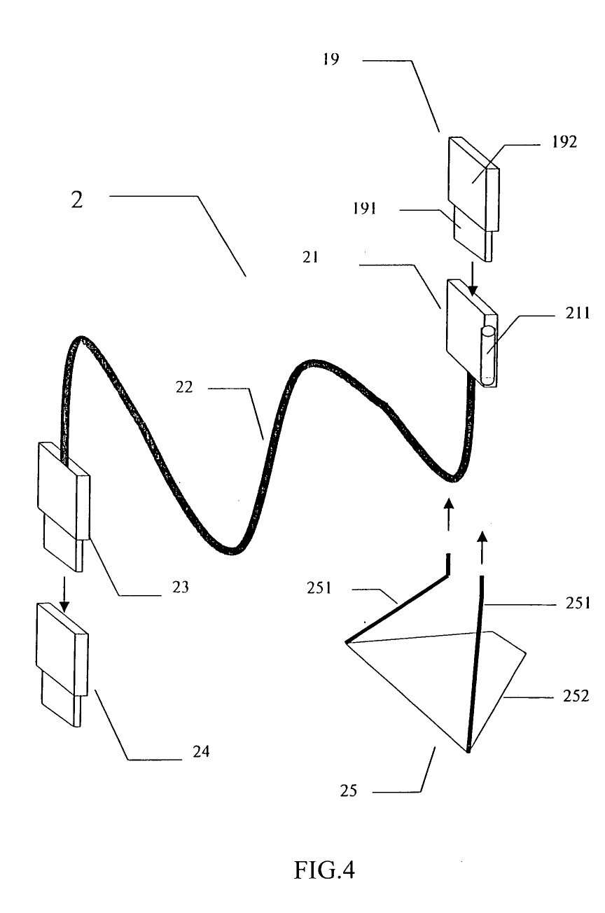

Referring to FIGS. 3 and 4, a wired camera lens interface device 2 is shown comprising a cable 22 for signal and power transmission, a camera lens socket 21 provided at one end of the cable 22 for receiving the connection plug 31 of a camera lens module 3, and a plug 23 provided at the other end of the cable 22 for connection to a socket 41 of a mobile electronic apparatus 4. If the connection plug 31 of the camera lens module 3 does not fit the camera lens slot 11, a camera lens adapter 19 shall be used. The camera lens adapter 19 has a socket 191 at one end for receiving the connection plug 31 of a camera lens module 3, and a plug 192 at the other end for connection to the camera lens socket 21. The cable 22 transmits power supply from the connected mobile electronic apparatus 4 to the attached camera lens module 3, and video images from the camera lens module 3 to the mobile electronic apparatus 4.

Further, if the plug 23 of the wired camera lens interface device 2 does not fit the socket 41 of the mobile electronic apparatus 4, a mobile apparatus adapter 24 shall be used to electrically connect the plug 23 of the wired camera lens interface device 2 to the socket 41 of the mobile electronic apparatus.

Further, a holder 25 may be used to support the camera lens socket 21 of the wired camera lens interface device 2 steadily on a place. The holder 25 comprises a base (stand) 252 and two locating rods 251 for fastening to the locating holes 211 at two opposite lateral sides (of the outer shell) of the camera lens socket 21.

A prototype of camera lens interface device has been constructed with the features of FIGS. 1˜4. The camera lens interface device functions smoothly to provide all of the features discussed earlier.

Although particular embodiments of the invention have been described in detail for purposes of illustration, various modifications and enhancements may be made without departing from the spirit and scope of the invention. Accordingly, the invention is not to be limited except as by the appended claims.

1. A wireless camera lens interface device connectable between a camera lens module and a mobile electronic apparatus for enabling said mobile electronic apparatus to control said camera lens module to pick up video images, said camera lens module having a plug for connection to said wireless camera lens interface device, said wireless camera lens interface device comprising:
a camera lens slot adapted to receive the plug of said camera lens module;
a voice pickup unit adapted to pick up external voices;
a central processing unit adapted to receive and process video signal from said camera lens module and voice signal from said voice pickup unit;
a wireless communication module electrically connected to said central processing unit and adapted to receive and process video and voice signals from said central processing unit for transmitting to said mobile electronic apparatus wirelessly, and to receive and process signal from said mobile electronic apparatus for controlling the operation of said camera lens module through said central processing unit;
antenna means electrically connected to said wireless communication module for receiving wireless signal from said mobile electronic apparatus and transmitting video and voice signals from said wireless communication module to said mobile electronic apparatus; and
a power unit adapted to provide power supply to said camera lens interface device and said camera lens module.

2. The wireless camera lens interface device as claimed in claim 1, further comprising indicator light means for operation status indication.

3. The wireless camera lens interface device as claimed in claim 1, wherein said power unit is comprised of a battery.

4. The wireless camera lens interface device as claimed in claim 3, wherein said battery is compatible to said mobile electronic apparatus.

5. The wireless camera lens interface device as claimed in claim 1, wherein said power unit comprises a power supply circuit electrically connected to said central processing unit, and a power jack provided at one end of said power supply circuit and exposed to the outside of said wireless camera lens interface.

6. The wireless camera lens interface device as claimed in claim 1, further comprising a camera lens adapter, said camera lens adapter comprising a socket for receiving the plug of said mobile electronic apparatus and a plug for connection to said camera lens slot.

7. The wireless camera lens interface device as claimed in claim 1, further comprising a power switch adapted to switch on/off said power unit

8. The wireless camera lens interface device as claimed in claim 7, wherein said power switch is a remote-control type power switch.

9. The wireless camera lens interface device as claimed in claim 1, wherein said voice pickup unit is a fixed microphone.

10. The wireless camera lens interface device as claimed in claim 1, wherein said wireless communication module provides multiple wireless signal transmitting functions, including local area wireless network function, bluetooth wireless communication function, and infrared wireless transmitting function.

11. The wireless camera lens interface device as claimed in claim 10, wherein said antenna means comprises multiple antennas to fit the multiple wireless signal transmitting functions.

12. A wired camera lens interface device connectable between a camera lens module and a mobile electronic apparatus for enabling said mobile electronic apparatus to control said camera lens module to pick up video images, said camera lens module having a plug for connection to said wired camera lens interface device, said mobile electronic apparatus comprising a socket for receiving said wired camera lens interface device and a display screen for video output, said wired camera lens interface device comprising:
a cable for signal and power transmission, said cable having a first end and a second end;
a camera lens socket provided at the first end of said cable for receiving the connection plug of said camera lens module; and
a plug provided at the second end of said cable for connection to the socket of said mobile electronic apparatus for enabling said mobile electronic apparatus to control said camera lens module to take video images for display through said display screen.

13. The wired camera lens interface device as claimed in claim 12, further comprising a camera lens adapter for connecting said camera lens module to said camera lens socket, said camera lens adapter comprising a socket for receiving the plug of said camera lens module and a plug for connection to said camera lens socket.

14. The wired camera lens interface device as claimed in claim 12, further comprising a mobile apparatus adapter adapted to connect the plug of said wired camera lens interface device to the socket of said mobile electronic apparatus, said mobile apparatus adapter comprising a socket for receiving the plug of said wired camera lens interface device and a plug for connection to the socket of said mobile electronic apparatus.

15. The wired camera lens interface device as claimed in claim 12, further comprising a holder adapted to hold said camera lens socket in place, said holder comprising a base for positioning and two locating rods for fastening to a respective locating holes at each of two opposite lateral sides of said camera lens socket.
